(19) United States
(12) Patent Application Publication
(10) Pub. No.: US 2015/0094938 A1
(43) Pub. Date: Apr. 2, 2015

(54) SYSTEM FOR PREVENTING A MECHANICAL DAMAGE OF AN INTERNAL COMBUSTION ENGINE DUE TO AN INEFFICIENT LUBRICATION OF THE ENGINE ITSELF

(71) Applicant: FPT Industrial S.P.A., Torino (IT)

(72) Inventor: Bruno Aimar, Cartignano (IT)

(21) Appl. No.: 14/494,805

(22) Filed: Sep. 24, 2014

(30) Foreign Application Priority Data
Sep. 30, 2013 (IT) MI2013A001608

(51) Int. Cl. F02D 41/00; F01M 11/10; F02D 41/06; F01D 25/18; F02D 41/22

(52) U.S. Cl. CPC F02D 41/0007; F01D 25/18; F02D 41/22; F02D 41/064; F01M 11/10; F05D 2220/40
USPC 701/113

(57) ABSTRACT

System for preventing a mechanical damage of an internal combustion engine, due to an inefficient lubrication of the engine itself, comprising means for measuring or estimating a pressure of a lubrication circuit (P) of the internal combustion engine, processing means (ECU) configured to activate means for preventing a mechanical damage of the internal combustion engine (E) at each starting of the latter, until said pressure is below a predetermined threshold.

### CROSS REFERENCE TO RELATED APPLICATIONS

The present application claims priority to Italian Patent Application No. MI2013A001608 filed Sep. 30, 2013, the entirety of the disclosures of which are expressly incorporated herein by reference.

### STATEMENT RE: FEDERALLY SPONSORED RESEARCH/DEVELOPMENT

Not Applicable.

### APPLICATION FIELD OF THE INVENTION

The present invention refers to the field of the system for protecting the mechanical elements of an internal combustion engine, possibly supercharged. In particular the present invention refers to the field of the systems for preventing the damage of a turbo-supercharging unit.

### DESCRIPTION OF THE PRIOR ART

The lubricating circuit of an internal combustion engine tends to empty, when the engine is stopped, due to the gravitational effect.

After starting the engine, a certain time is thus necessary to fill and pressurize the respective lubricating circuit.

Furthermore, the viscosity of the lubricating oil is highly influenced by the environmental conditions. Thus, when the engine is cold, at low temperature, the viscosity of the oil increases and consequently it takes more time for the oil to reach the different mechanical parts of the internal combustion engine, such as the housing of the turbine and/or the compressor and thus the bearings thereof.

In this interval of time, such mechanical parts run without oil, with a serious deterioration of the parts themselves.

Thus, such mechanical parts, above all belonging to the turbo-supercharger unit may have reliability problems if over-used before the lubricating circuit is efficient.

### SUMMARY OF THE INVENTION

Therefore the aim of the present invention is to overcome all the aforementioned drawbacks and to provide a system for preventing a mechanical damage of an internal combustion engine, due to an inefficient lubrication of the latter.

The basic idea of the present invention is to provide a system that is able to estimate the inefficiency conditions of the lubricating circuit and to limit the degradation of the mechanical parts.

An object of the present invention is a system for preventing a mechanical damage of an internal combustion engine, due to an inefficient lubrication of the latter, in accordance with claim 1.

According to a preferred alternative embodiment of the invention, a possible over-use of the mechanical part of the engine, turbo-supercharger included, is estimated, limiting or inhibiting such over-use. In other words, the engine, as well as the supercharging unit, are forced to reduce their number of revolutions.

Another object of the present invention is an internal combustion engine equipped with the aforementioned control system.

A further object of the present invention is a vehicle comprising an internal combustion engine equipped with the aforementioned control system.

The claims are an integral part of the present description.

### BRIEF DESCRIPTION OF THE FIGURES

Further purposes and advantages of the present invention will become clear from the following detailed description of a preferred embodiment (and of its alternative embodiments) and the drawings that are attached hereto, which are merely illustrative and non-limitative, in which:

FIG. 1 shows schematically the system that is object of the present invention, applied to an internal combustion engine,

FIG. 2 shows a logic diagram of the functioning of the system of FIG. 1.

In the figures the same reference numbers and letters identify the same elements or components.

### DETAILED DESCRIPTION OF THE PREFERRED EMBODIMENTS OF THE INVENTION

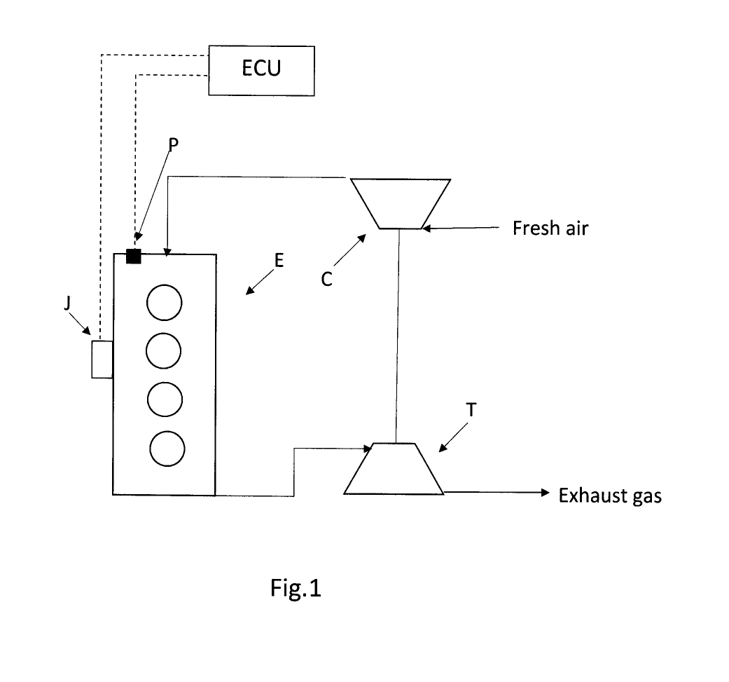

FIG. 1 shows a scheme of an internal combustion engine E equipped with at least one turbo-supercharging stage comprising a turbine T having an inlet connected with the exhaust manifold of the internal combustion engine and a compressor C, driven by the turbine T, having an outlet connected with the intake manifold of the internal combustion engine E.

The engine is equipped per se with processing means, for example an engine control unit ECU, means for measuring a pressure of the lubricating oil P and supply means J, generally the fuel injection system, controlled by the engine control unit ECU and/or by means for controlling the supercharging of the internal combustion engine, namely at least one among:
means for controlling the geometry of the turbine,
means for controlling a waste gate valve,
means for controlling an engine brake valve on the exhaust pipe upstream of the turbine,
means for controlling an exhaust gas recirculation valve between the exhaust duct upstream of the turbine and the intake duct downstream of the compressor,
means for controlling an air limiting valve (throttle) on the intake duct.

The system that is object of the invention allows to actuate a monitoring of the continuous type of the lubricating oil pressure and to actuate one or more prevention strategies, at least when the engine is started, until the oil pressure is stabilized and exceeds a predefined threshold.

Such strategies, for example, may include
displaying a light or a message in the dashboard, which indicates a condition of “vehicle not ready” and/or
limiting the torque delivered by the internal combustion engine and/or
limiting the maximum number of revolutions per minute of the internal combustion engine and/or of a respective turbo-supercharging unit.

It is worth pointing out that the second and the third aforementioned strategies are strongly interrelated to each other, since a reduction of the revolutions per minute corresponds to a reduction of the torque delivered and vice versa.

For the rotating mechanical parts, the maximum number of revolutions per minute (rpm_max_no_lub) to which such part can be subjected when the lubricating circuit is not efficient, is defined during the design stage.

Such maximum number of revolutions per minute (rpm_max_no_lub) can be several times lower than the maximum number of revolutions per minute (rpm_max) that such parts can bear in conditions of optimal lubrication.

Preferably, when a possible over-use of the mechanical parts is detected, namely when the speed of rotation is too high, the system brings such speed of rotation back to the maximum acceptable speed in conditions of inefficient lubrication (rpm_max_no_lub).

According to a preferred embodiment of the invention, it is possible to intervene on the supply means J, after setting a fixed rpm limit in the supply map of the engine, or a variable rpm limit can be set, calculated according to the following formula:

rpm=rpm_mis−C_mis×f(P,T)

rpm: correct speed of rotation, namely forced by the prevention system,

rpm_mis: current speed of rotation,

C_mis: torque delivered

f(P,T): conversion factor of the torque delivered into rpm, as a function of ambient pressure P and of ambient temperature T.

A limitation of the number of revolutions per minute of the internal combustion engine consequently implies a reduction of the number of revolutions per minute of a respective turbo-supercharging unit.

According to another preferred alternative embodiment of the invention, the flow rate of the intake air of the engine is reduced, by means of at least one of
means for controlling the geometry of the turbine,
means for controlling a wastegate valve,
means for controlling an engine brake valve on the exhaust pipe upstream of the turbine,
means for controlling an exhaust gas recirculation valve between the exhaust duct upstream of the turbine and the intake duct downstream of the compressor,
means for controlling an air limiting valve (throttle) on the intake duct,

so as to reduce the number of revolutions per minute of the turbo-supercharging unit. It is evident that regardless of the fact that one acts either on the supply maps, namely on the injection system, or on the supercharging system, a reduction of the overall revolutions per minute of the engine, supercharging unit included, is obtained.

According to a preferred alternative embodiment of the invention, the prevention system is activated when the engine is started and stays active until a full filling and pressurization of the lubricating circuit is detected.

In these case there are two options:

the pressure of the lubricating oil is either measured or estimated.

It is worth pointing out that, since the pressure sensor is generally placed upstream of the turbine, it is necessary to estimate the pressurization time in the part of the circuit that is comprised between the sensor and the turbine, so as to avoid considering the circuit as completely efficient when it is not yet.

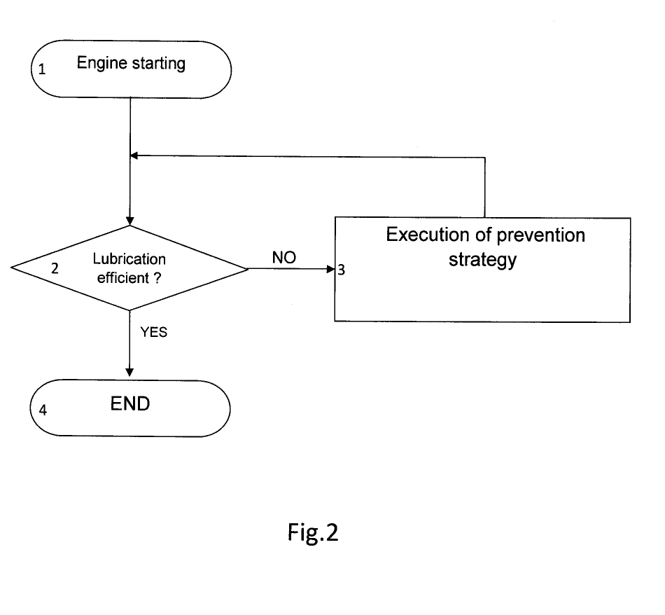

FIG. 2 shows a flow diagram showing an implementation example of the present system:
step 1: detection of the engine starting,
step 2: measuring of a pressure value of the lubricating oil and if such value exceeds a predetermined threshold (SI), then
step 3: the circuit is considered efficient, and the cycle is ended, otherwise
step 4: (NO) execution of at least one of the aforementioned strategies and back to the measuring (step 2) of the pressure of the lubricating oil.

Thus, the system can be enabled at every starting of the engine and disabled as soon as the pressure of the lubrication oil reaches said predefined threshold.

The present invention may advantageously be realized by means of a computer program, which comprises program code means performing one or more steps of said method, when said program is run on a computer. For this reason the scope of the present patent is meant to cover also said computer program and the computer-readable means that comprise a recorded message, such computer-readable means comprising the program code means for performing one or more steps of such method, when such program is run on a computer.

It will be apparent to the person skilled in the art that other alternative and equivalent embodiments of the invention can be conceived and reduced to practice without departing from the scope of the invention.

By virtue of the present invention it is possible to avoid the over-use of the mechanical parts of the engine, reducing the probability of mechanical damages due to the non optimal lubrication thereof.

Furthermore, compared with solutions of the mechanical type, it is possible to avoid any mechanical modification that is usually more expensive than the present invention, which can be advantageously implemented via software, by means of the aforementioned engine control unit ECU, or by means of any further electronic control unit onboard of the vehicle.

From the description set forth above it will be possible for the person skilled in the art to embody the invention with no need of describing further construction details. The elements and the characteristics described in the different preferred embodiments may be combined without departing from the scope of the present application. What is described in the description of the prior art, if not explicitly excluded in the detailed description, has to be considered in combination with the characteristics of the present invention, forming an integral part of the present invention.

1. System for preventing a mechanical damage of an internal combustion engine, due to an inefficient lubrication of the engine itself, comprising means for measuring or estimating a pressure of a lubrication circuit (P) of the internal combustion engine, processing means (ECU) configured to activate means for preventing a mechanical damage of the internal combustion engine (E) at each starting of the latter, until said pressure is below a predetermined threshold.

2. System according to claim I, wherein said prevention means comprise:
a light or a message indicating a condition of “vehicle not ready” and/or
means for limiting a torque delivered by the internal combustion engine and/or
means for limiting the maximum revolutions per minute of the internal combustion engine and/or of a respective turbo-supercharging unit and/or
means for controlling an exhaust gas recirculation valve between the exhaust pipe upstream of the turbine and the intake pipe downstream of the compressor and/or
means for controlling an air limiting valve (throttle) on the intake pipe,
in order to reduce the number of revolutions per minute of the turbo-supercharging unit.

3. System according to claim 2, wherein when said prevention means comprise means for limiting a maximum number of revolutions per minute of the internal combustion engine, said limiting means are configured to force the speed of rotation of the engine to a fixed rpm value, or to a value given by the following formula:
rpm=rpm_mis−C_mis×f(P,T)
rpm_mis: current speed of rotation,
C_mis: torque delivered
f(P,T): conversion factor of the torque delivered into rpm, as a function of ambient pressure T and of ambient temperature T.

4. System according to claim 2, wherein when said prevention means comprise means for limiting a maximum number of revolutions per minute of the internal combustion engine, said prevention means are adapted to intervene on
fuel supply means (J) of the internal combustion engine to reduce the number of revolutions per minute of the internal combustion engine (E) and consequently of the turbo-supercharging unit (T, C) and/or they are adapted to intervene on at least one of
means for controlling the geometry of the turbine,
means for controlling a waste gate valve,
means for controlling an engine brake valve on the exhaust pipe upstream of the turbine,
means for controlling an exhaust gas recirculation valve between the exhaust duct upstream of the turbine and the intake duct downstream of the compressor,
means for controlling an air limiting valve (throttle) on the intake duct, in order to reduce the number of revolutions per minute of the turbo-supercharging unit (T, C).

5. Method for actuating a system for preventing a mechanical damage of an internal combustion engine, due to an inefficient lubrication of the engine itself, the system comprising means for measuring or estimating a pressure of a lubrication circuit (P) of the internal combustion engine, processing means (ECU) configured to activate means for preventing a mechanical damage of the internal combustion engine (E) at each starting of the latter, until said pressure is below a predetermined threshold, the method comprising the following steps:
(step 1) detecting the engine starting,
(step 2) measuring a pressure value of the lubricating oil and if such value exceeds a predetermined threshold (SI), then
(step 3) the circuit is considered efficient, and the cycle is ended, otherwise
(step 4) (NO) at least one prevention strategy is executed and back to the measuring (2) of the pressure of the lubricating oil.

6. Method according to claim 5, wherein said prevention strategy is at least one of the following:
displaying a light or a message indicating a condition of “vehicle not ready” and/or
limiting the torque delivered by the internal combustion engine and/or
limiting the maximum number of revolutions per minute of the internal combustion engine and/or of a respective turbo-supercharging unit.

7. Internal combustion engine comprising a system for preventing a mechanical damage of the engine itself, due to an inefficient lubrication, the system comprising means for measuring or estimating a pressure of a lubrication circuit (P) of the internal combustion engine, processing means (ECU) configured to activate means for preventing a mechanical damage of the internal combustion engine (E) at each starting of the latter, until said pressure is below a predetermined threshold.

8. Terrestrial vehicle comprising an internal combustion engine according to claim 7.
